(19) United States
(12) Patent Application Publication
(10) Pub. No.: US 2016/0045393 A1
(43) Pub. Date: Feb. 18, 2016

(54) Chiropractic Adjuster Utilizing Regional Motion Analysis

(71) Applicant: Mechanical Motion Solutions LLC, McMurray, PA (US)

(72) Inventor: Maurice A. Pisciottano, Venetia, PA (US)

(21) Appl. No.: 14/828,690

(22) Filed: Aug. 18, 2015

Related U.S. Application Data
(60) Provisional application No. 62/038,550, filed on Aug. 18, 2014.

(51) Int. Cl. A61H 23/06; A61H 1/00

(52) U.S. Cl. CPC A61H 23/06; A61H 1/008; A61H 2201/0153; A61H 2201/1253

(57) ABSTRACT

An implement head adapted for connection to an impactor of an adjustment apparatus to perform a regional tissue analysis and/or treatment therapy. The implement head includes a base member for connecting the base member to the impactor, a first set of three projections extending in substantially the opposite direction of the base member, and a second set of three projections extending in substantially the opposite direction of the base member. The second set of three projections being substantially parallel to the first set of three projections.

### CROSS-REFERENCE TO RELATED APPLICATIONS

This application claims the benefit of U.S. Provisional Patent Application No. 62/038,550, filed Aug. 18, 2014, which is herein incorporated by reference in its entirety.

### BACKGROUND OF THE INVENTION

1. Field of the Invention

The invention relates generally to an adjustment device and more particularly, to an adjustment device for performing regional motion analysis and treatment and an associated method.

2. Description of Related Art

The American National Institute of Health and Pain Consortium estimates that one third of the population experiences some form of persistent pain. The primary causes of pain are joint/tissue fixation, nerve interference, and inflammation. The misalignment of joints, especially along the spinal column, is one of the leading causes of disorders that affects the nerves, muscles, and organs. Various chiropractic devices to treat the misalignment of joints are known. Examples of such chiropractic adjusting devices include the Pro-Adjuster®, the Activator®, the Arthostim®, the Impulse®, and the PulstarFras®.

Each of these chiropractic adjustment devices perform a specific analysis and associated treatment. A specific analysis, as provided herein, is defined as an analysis in which the resistance of each vertebrae are analyzed individually. Each of the previously mentioned chiropractic adjustment apparati utilize an impactor fitted with an implement tip having two lateral points. To perform a specific analysis, the practitioner places each contact point of the implement tip on a lateral position of a single vertebrae to test the resistance of each vertebrae of the spine individually.

While known treatment apparati are generally effective at performing a specific analysis, such apparati are not without limitation. One of the largest challenges faced by chiropractic adjustment devices is that the specificity of the apparati exceed the ability of the human body to be analyzed. The complexity and interconnection of joints, ligaments, muscles, and the surrounding tissue in the body make it such that there is no way to test resistance of a joint by itself, external of the ligaments, muscles, and other surrounding tissue. Likewise, there is also no way to treat a joint and not affect the adjacently interconnected tissue.

Although the information obtained from a specific analysis is accurate as it relates to the individual vertebrae, because the information obtained is so specific, specific analysis is unable to account for the complex interconnections of the body and thus is often times ineffective in diagnosing the origin of the symptoms and in providing effective treatment. For example, in performing a specific analysis, the concentrated focus on an individual vertebrae can cause a practitioner to overlook causes of symptoms that can only be diagnosed from broader, regional analysis, such as tightness in the ligaments between adjacent vertebrae or surrounding tissue. Moreover, an adjustment of an individual vertebrae will adjust adjacent vertebrae and interconnected tissue that may not require adjustment or that may require a different adjustment all together.

For these reasons, an apparatus that can efficiently and accurately perform a resistance analysis of human joints as a whole is desired. The adjustment device and associated method should be specific enough to accurately localize individual vertebrae of resistance but not so specific that it exceeds the ability of the human body to be analyzed.

### SUMMARY OF THE INVENTION

The present invention overcomes the problems associated with the prior art because the impactor head of the device analyzes and treats local regions of a patient's spine, providing the practitioner with an analysis of the tissue resistance of a specific region, thereby providing the practitioner with data useful in diagnosing symptoms of a joint.

Provided herein is an implement head adapted for connection to an impactor of an adjustment apparatus to perform a regional tissue analysis and/or treatment therapy. The implement head includes a base member for connecting the base member to the impactor, a first set of three projections extending in substantially the opposite direction of the base member, and a second set of three projections extending in substantially the opposite direction of the base member. The second set of three projections are substantially parallel to the first set of three projections.

In one non-limiting embodiment the first set of three projections and the second set of three projections form three U-shaped members such that each U-shaped member has two bilateral contact points. The first set of three projections are located on one side of a longitudinal axis and the second set of three projections are located on the opposite side of the longitudinal axis. The longitudinal axis is concentric to the base member.

Also provided herein is a method for performing regional analysis. The method includes testing three adjacent vertebrae of an individual's spine simultaneously, testing a total of nine separate regions, recording a tissue resistance of each of the nine regions; and analyzing the recorded tissue resistance of the nine regions.

### BRIEF DESCRIPTION OF THE DRAWING(S)

The present invention will now be described in further details with reference to the accompanying figures, in which:

FIG. 1 is a perspective view of an implement head device as described herein.

FIG. 2 is a front view of the implement head device of FIG. 1.

FIG. 3 is a side view of the implement head device of FIG. 1.

FIG. 4 is a top perspective view of a nib disposed on a projection of the implement head device of FIG. 1.

FIG. 5 is a top view of the implement head device of FIG. 1.

FIG. 6 is a schematic illustration of nine regional test sites for analyzing tissue analysis while performing a regional analysis as described herein.

### DESCRIPTION OF THE INVENTION

For purposes of the description hereinafter, spatial orientation terms relate to the embodiment of the invention, as it is oriented in the accompanying drawing figures. In the context of the device described herein, “distal” refers to a direction away from an end of the device adapted for engagement with an impactor, while “proximal” is the opposite of distal, and refers to a direction towards an end of the device adapted for engagement with the impactor. Further, it is to be understood that the invention may assume many alternative variations and embodiments, except where expressly specified to the contrary.

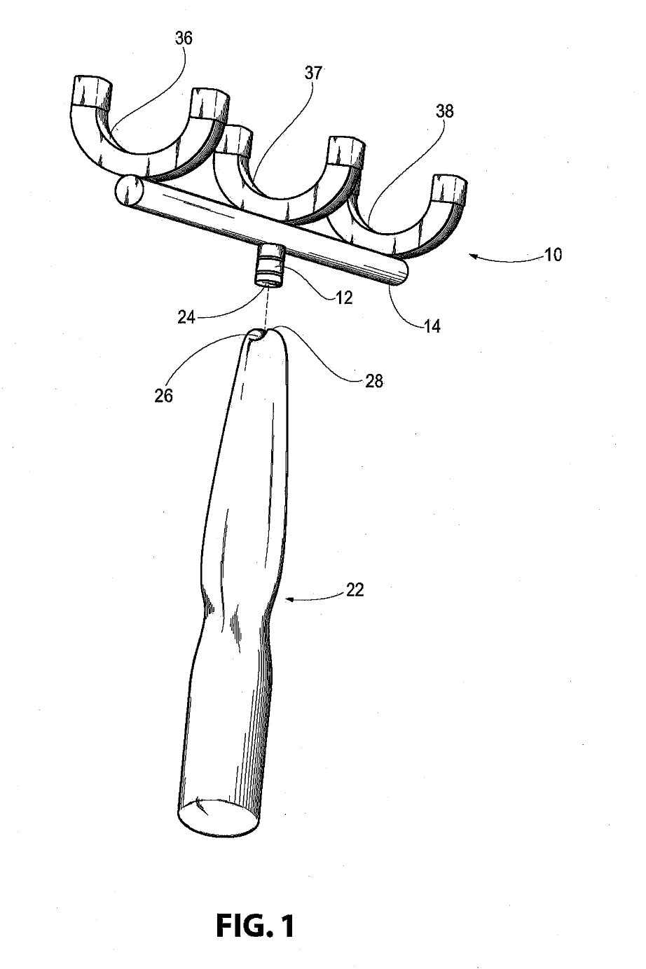

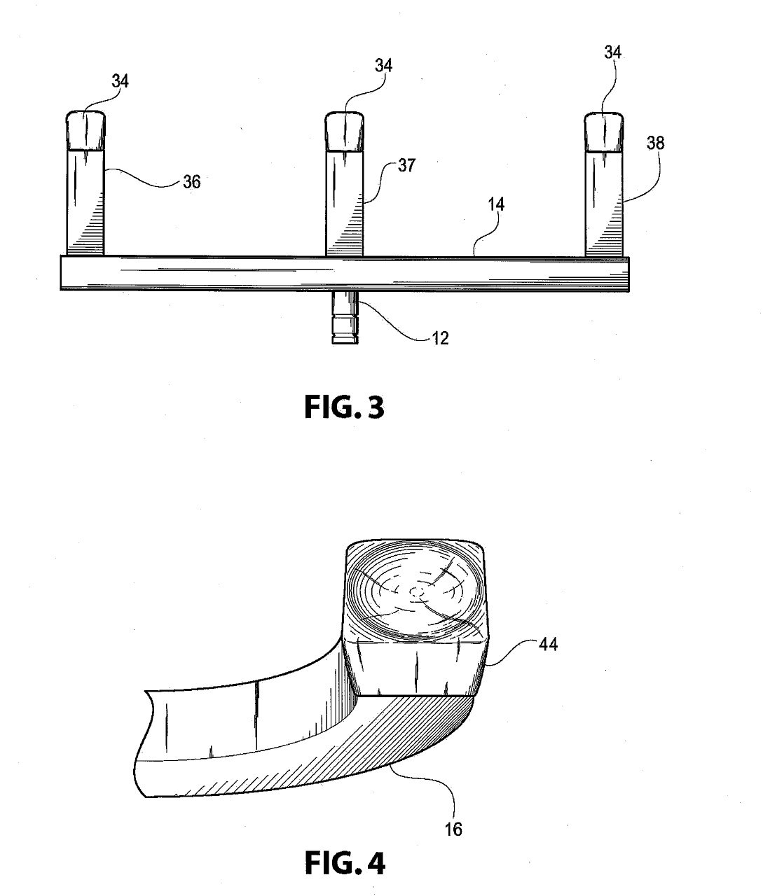

FIGS. 1-5 depict one non-limiting embodiment of a device as described herein. In reference to FIGS. 1-5, an implement head 10 for chiropractic adjustment comprises a base member 12, a connecting member 14, and six projections 16, 17, 18, 19, 20, 21 extending from the connecting member 14. The impactor head 10 is adapted to connect to an impactor 22 of a chiropractic adjustment device and “tap” the patient's tissues. A tap may be in the form of a single actuation of the implement head as is commonly known in the art, or in the form of multiple high-frequency, low amplitude, low force impulses to analyze tissue resistance and/or to provide a therapeutic outcome. As is set forth in greater detail below, the configuration of the implement head 10 advantageously enables a physician to perform a regional spinal analysis and avoid the disadvantages inherent in a specific spinal analysis. As described herein, regional analysis refers to testing tissue resistance of three adjacent vertebrae; however, it is contemplated that a plurality of adjacent vertebrae may also be analyzed using the disclosed apparatus and method. It is also contemplated that a region of interconnected tissue, located a distance from the spine, may also be analyzed and treated using the disclosed apparatus and method.

With reference to FIG. 1, the implement head 10 may be secured to the impactor 22 via an interference fit. To secure the implement head 10 to the impactor 22 the proximal end 24 of the base member 12 is inserted into a correspondingly shaped recess 26 disposed on a distal end 28 of the impactor 22. The proximal end 24 of the base member may be any shape, including cylindrical or rectangular, so long as an interference fit is created with the correspondingly shaped recess 24 such that movement, including rotation, of the implement head 10 with respect to the impactor 22 is prevented.

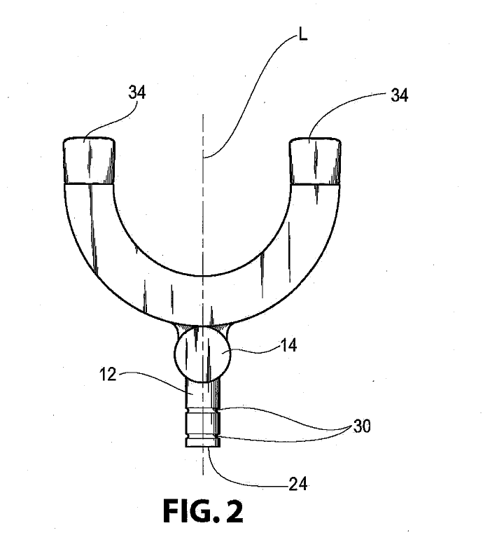

With specific reference to FIG. 2, a unique keyway 30 is located adjacent the proximal end 24 of the base member 12 to supplement the interference fit in preventing movement during analysis or treatment. This is accomplished by a corresponding boss (not shown) located within the recess 26 of the actuator 22. The keyway 30 also prevents the implement head 10 from being secured to an unauthorized or incompatible impactor 22 for which a corresponding boss is not located.

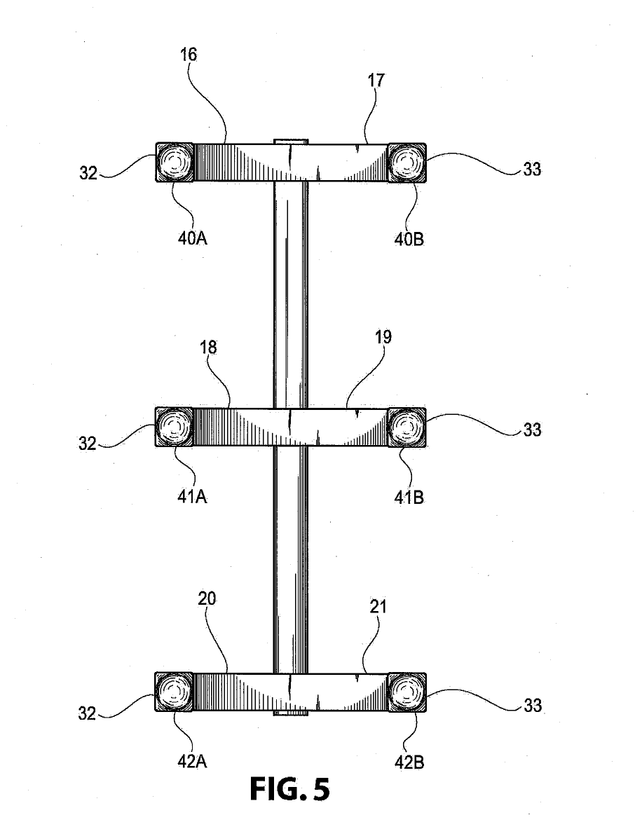

With reference to FIGS. 2; 3 and FIG. 5, the implement head has a longitudinal axis L that is concentric to the base member 12. The connecting member 14 is perpendicularly secured to the base member 12, with respect to the longitudinal axis of the implement head 10. In one embodiment, the six projections 16, 17, 18, 19, 20, 21, extend from the connecting member 14 in an opposing direction of the base member 12. With specific reference to FIG. 5, the six projections 16, 17, 18, 19, 20, 21 are grouped into two sets of three vertically aligned projections. A first set of three projections 32, including projections 16, 18, 20, are vertically aligned on one side of the longitudinal axis while a second set of three projections 33, comprising 17, 19, 21, are vertically aligned on the opposing side of the longitudinal axis. The first set and second set of projections are vertically aligned so that the first set of three projections 32 and the second set of three projections 33 are parallel to one another.

In one embodiment the first set of three projections and the second set of the three projections are configured such that each pair of complimentary bilateral projections (16, 17), (18, 19), and (20, 21) are mirror images of one another and equidistantly spaced from the connecting member 14. Each projection is connected to its complementary projection such that three U-shaped members 36, 37, 38 are formed, as illustrated in FIG. 1. Each U-shaped member 36, 37, 38 includes two bilateral contact points 40A, 40B, 41A, 41B, 42A, 42B for placement on either side of an individual vertebrae. In another embodiment a V-shaped or an alternatively shaped member having two bilateral contact points may be formed.

The distal end 34 of each projection 16, 17, 18, 19, 20, 21 extends a distance above the connecting member such that during an analysis and/or treatment each distal end 34 lies flush against the treatment area.

The base member 12, the connecting member 14, and each of the six projections 16, 17, 18, 19, 20, 21 may be formed as one integral piece or as separate pieces secured together by a process such as molding. The implement head may be made from any metal, such as aluminum, a metal compound, or any other suitable material.

With specific reference to FIG. 4, a nib 44 or rubber tip is disposed over the distal end of each projection 16, 17, 18, 19, 20, 21 and defines a concave recessed portion thereon to adhere to a treatment region. In other embodiments the nib 44 can alternatively be convex or flat in shape.

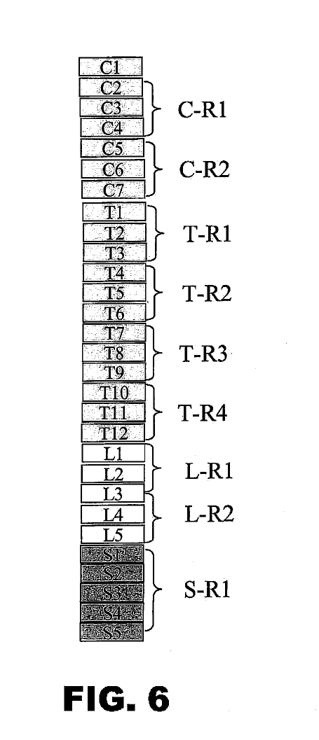

With reference to FIG. 6, a method for using the implement head 10 device previously described, in connection with an adjustment device, to perform a regional motion analysis and therapy is described hereinafter. The method comprises the practitioner testing tissue resistance by tapping or testing a series of regions, for example, nine areas of the patient's spine, sequentially from the top of the spine to the bottom of the spine.

With the implement head 10 secured to the impactor 22 as described above, the practitioner may apply the implement head 10 to a treatment area with the nib 44 of each contact point 40A, 40B, 41A, 41B, 42A, 42B laying flush against the treatment area so that the nib 44 of each bilateral projection (16, 17), (18, 19), and (20, 21) is placed on a lateral side of an individual vertebrae. After the implement head 10 has been positioned on a treatment region, the practitioner can test the tissue resistance of the region as a whole by pressing the implement head 10 against the treatment area. When a threshold force, such as (3 lbf, is applied to the implement head 10 the impactor 22 will activate and cause the implement head 10 to tap the treatment area. This method advantageously provides the practitioner with tissue resistance information of a localized region including not only an individual vertebrae, but also including information pertaining to the movement analysis of a particular vertebrae, its adjacent vertebrae, and surrounding tissue in which the vertebrae has a dependent relationship.

With continued reference to FIG. 6, the method comprises the practitioner testing nine regions of the patient's spine, sequentially from top to bottom. In one non-limiting embodiment, two regions of cervical vertebrae, four regions of thoracic vertebrae, two regions of lumbar vertebrae, and one region of the fused sacrum vertebrae are tested. For example, the practitioner may test the following vertebrae in sequential order: (1) cervical 2, 3, and 4; (2) cervical 5, 6, and 7; (3) thoracic 1, 2, and 3; (4) thoracic 4, 5, and 6; (5) thoracic 7, 8, and 9; (6) thoracic 10, 11, and 12; (7) lumbar 1, 2, and 3; (8) lumbar 3, 4, and 5; and (9) any three adjacent vertebrae of the fused sacrum region of an individual's spine.

While specific embodiments of the implement head device and a method for using the device have been described in detail herein, it will be appreciated by those skilled in the art that various modifications and alternatives to these details could be developed in light of the overall teachings of the disclosure. Although the regional analysis method disclosed herein provides for the simultaneous tissue resistance analysis of three adjacent vertebrae, it is appreciated, for example, that the particular regions of testing, the number of regions tested, the sequence in which the regions are tested, and the number of vertebrae simultaneously tested, may be altered.

Accordingly, the particular arrangements disclosed are meant to be illustrative only and not limiting as to the scope of the invention which is to be given the full breadth of the claims appended and any and all equivalents thereof.

The invention claimed is:

1. An implement head comprising:
a base member adapted for connection to an impactor of an adjustment apparatus;
a first set of three projections extending in substantially the opposite direction of the base member; and
a second set of three projections extending in substantially the opposite direction of the base member, wherein the second set of three projections is substantially parallel to the first set of three projections.

2. The implement head of claim 1, wherein the first set of three projections and the second set of three projections form three U-shaped members such that each U-shaped member has two bilateral contact points.

3. The implement head of claim 2, further comprising:
a connecting member securing each U-shaped member to the connecting member and the connecting member to the base member.

4. The implement head of claim 1, wherein the first set of three projections are located on one side of a longitudinal axis and the second set of three projections are located on the opposite side of the longitudinal axis and wherein the longitudinal axis is concentric to the base member.

5. The implement head of claim 4, wherein the first set of three projections and second set of three projections are equidistant to the longitudinal axis.

6. The implement head of claim 1, wherein the base member of the implement tip is detachably connectable to the impactor of the adjustment apparatus via a friction fit.

7. The implement head of claim 1, wherein the base member is cylindrical in shape.

8. The implement head of claim 1, wherein the base member is rectangular in shape.

9. The implement head of claim 1, wherein a keyway is disposed adjacent the proximal end of the base member.

10. The implement head of claim 1, wherein the implement head is aluminum.

11. The implement head of claim 1, wherein the first set of three projections and the second set of three projections have rubber nibs.

12. The implement head of claim 11, wherein a distal end of each rubber nib is rounded.

13. The implement head of claim 11, wherein a distal end of each rubber nib defines a concave recessed area.

14. The implement head of claim 11, wherein a distal end of each rubber nib is flat.

15. The implement head of claim 11, wherein a distal end of each of the three projections of the first set of projections and a distal end of each of the three projections of the second set of projections are aligned along a plane.

16. The implement head of claim 1, wherein the first set of projections and the second set of projections are cylindrical in shape.

17. A method of performing regional analysis comprising:
tapping three adjacent vertebrae of an individual's spine simultaneously;
tapping nine separate regions of three adjacent vertebrae;
recording a tissue resistance of each of the nine regions; and
analyzing the recorded tissue resistance of the nine regions.

18. The method of claim 17, wherein two regions within a cervical spine, four regions within a thoracic spine, two regions within a lumbar spine, and one region within a fused sacrum spine are tapped.

19. The method of claim 18, wherein the nine regions of the spine that are analyzed are tapped sequentially from the cervical spine to the fused sacrum spine.

20. The method of claim 18, wherein the nine regions of the spine that are analyzed comprise the following three vertebrae regions:
cervical 2, 3, and 4;
cervical 5, 6, and 7;
thoracic 1, 2, and 3;
thoracic 4, 5, and 6;
thoracic 7, 8, and 9;
thoracic 10, 11, and 12;
lumbar 1, 2, and 3;
lumbar 3, 4, and 5; and
any three adjacent vertebrae of the fused sacrum portion of the individual's spine.
